(19) United States
(12) Patent Application Publication
(10) Pub. No.: US 2025/0321329 A1
(43) Pub. Date: Oct. 16, 2025

(54) METHODS FOR CLEANING WINDOW OF LIDAR FOR VEHICLES, RANGING DEVICES AND VEHICLES

(71) Applicant: HESAI TECHNOLOGY CO., LTD., Shanghai (CN)

(72) Inventors: Xuezhou ZHU, Shanghai (CN); Shaoqing XIANG, Shanghai (CN)

(21) Appl. No.: 19/250,474

(22) Filed: Jun. 26, 2025

Related U.S. Application Data
(63) Continuation of application No. PCT/CN2023/142134, filed on Dec. 26, 2023.

(30) Foreign Application Priority Data
Dec. 26, 2022 (CN) 202211676008.0

(51) Int. Cl. G01S 7/497; B60S 1/08

(52) U.S. Cl. CPC G01S 7/497; B60S 1/0862; G01S 2007/4975

(57) ABSTRACT

Ranging devices and vehicles include a LiDAR. The LiDAR is fixed to an inside of a vehicle cover, and a field of view of the LiDAR forms a projection area on the vehicle cover. A cleaning range of a wiper of the vehicle at least partially coincides with the projection area. Methods for cleaning a window of a LiDAR for a vehicle includes: regulating operating parameter of at least one of the wiper or the LiDAR such that a cleaning operation of the wiper cooperates with a detection operation of the LiDAR; and controlling the wiper to perform the cleaning operation.

### CROSS-REFERENCE TO RELATED APPLICATIONS

This application is a continuation application of PCT Application No. PCT/CN2023/142134, filed on Dec. 26, 2023, which claims priority to Chinese Patent Application No. 202211676008.0, filed on Dec. 26, 2022, the content of which are incorporated herein by reference in their entireties.

### TECHNICAL FIELD

This disclosure is related to the technical field of LiDARs, and in particular, to methods for cleaning a window of a LiDAR for vehicles, ranging devices, and vehicles.

### BACKGROUND

LiDARs used in the advanced driving assistance system (“ADAS”) of passenger cars can suffer from stained windows in rainy or snowy weather or after long-term operation, which can cause the performance of the LiDAR to degrade to varying degrees, such as the reduction of long-distance detection capabilities and the occurrence of crosstalk and ghost images.

At present, a widely used approach is to provide additional cleaning devices to clean the LiDAR. A typical cleaning method is water spray cleaning.

However, additional cleaning devices have limited cleaning effectiveness and are costly. In addition, additional cleaning devices can affect the appearance of the passenger car.

### SUMMARY

This disclosure provides methods for cleaning a window of a LiDAR for vehicles, ranging devices and vehicles, in which a wiper is reused to clean the LiDAR's window, and the normal operation of the LiDAR is not affected during the cleaning, thus ensuring the detection performance of the LiDAR.

In a first aspect, this disclosure provides a method for cleaning a window of a LiDAR for a vehicle. The method includes: regulating an operating parameter of at least one of a wiper of the vehicle or the LiDAR. A cleaning operation of the wiper is configured to cooperate with a detection operation of the LiDAR. The LiDAR is fixed to an inside of a vehicle cover, a field of view of the LiDAR is configured to form a projection area on the vehicle cover, and a cleaning range of the wiper is configured to at least partially coincide with the projection area; and controlling the wiper to perform the cleaning operation.

Optionally, regulating the operating parameter of at least one of the wiper or the LiDAR includes: regulating the operating parameter of the at least one of the wiper or the LiDAR to maintain a predetermined distance between a current position of the wiper and a current scanning orientation of the LiDAR.

Optionally, regulating the operating parameter of the at least one of the wiper or the LiDAR to maintain the predetermined distance between the current position of the wiper and the current scanning orientation of the LiDAR includes: regulating the operating parameter of the at least one of the wiper or the LiDAR, and a time period is within a non-ranging time period of a frame of the LiDAR, and the wiper is configured to wipe across the projection area during the time period.

Optionally, regulating the operating parameter of the at least one of the wiper or the LiDAR to maintain the predetermined distance between the current position of the wiper and the current scanning orientation of the LiDAR further includes: determining whether a duration for the wiper to wipe across the projection area is shorter than or equal to a non-ranging duration of the frame of the LiDAR; and based on a determination that the duration for the wiper to wipe across the projection area is not shorter than or equal to the non-ranging duration of the frame of the LiDAR, changing the operating parameter of the at least one of the wiper or the LiDAR to cause the duration for the wiper to wipe across the projection area to be shorter than or equal to the non-ranging duration of the frame of the LiDAR.

Optionally, changing the operating parameter of the at least one of the wiper or the LiDAR to cause the duration for the wiper to wipe across the projection area to be shorter than or equal to the non-ranging duration of the frame of the LiDAR includes at least one of: accelerating an operating speed of the wiper; or lengthening the non-ranging duration of the frame of the LiDAR; or narrowing a scope of the projection area.

Optionally, lengthening the non-ranging duration of the frame of the LiDAR includes: keeping a frame rate of the LiDAR unchanged and shortening a ranging duration within the frame of the LiDAR; or keeping the ranging duration within the frame of the LiDAR unchanged and reducing the frame rate of the LiDAR; or reducing the frame rate of the LiDAR and shortening the ranging duration within the frame of the LiDAR.

Optionally, regulating the operating parameter of the at least one of the wiper or the LiDAR includes: determining the non-ranging time period of the frame of the LiDAR; determining a first duration for the wiper to enter the projection area; determining a first waiting duration based on the non-ranging time period of the frame of the LiDAR and the first duration, the first waiting duration is a waiting duration before the wiper is started; and in response to the wiper receiving a start signal, controlling the wiper to start after the first waiting period, and the wiper is configured to wipe across the projection area during the non-ranging time period of the LiDAR.

Optionally, regulating the operating parameter of the at least one of the wiper or the LiDAR includes: determining a first time period, and the wiper is located within the projection area during the first time period; and changing the operating parameter of the LiDAR, and the non-ranging time period of the LiDAR is configured to coincide with the first time period.

Optionally, regulating the operating parameter of the at least one of the wiper or the LiDAR to maintain the predetermined distance between the current position of the wiper and the current scanning orientation of the LiDAR includes: regulating the operating parameter of the at least one of the wiper or the LiDAR, and the current position of the wiper is configured to be ahead of or behind the current scanning orientation of the LiDAR.

Optionally, regulating the operating parameter of the at least one of the wiper or the LiDAR includes: determining the current scanning orientation of the LiDAR; determining the current position of the wiper; determining a second waiting duration based on the current scanning orientation of the LiDAR and the current position of the wiper, the second waiting duration is a waiting duration before the wiper is started; and in response to the wiper receiving a start signal, controlling the wiper to start after the second waiting duration, and the current position of the wiper is configured to be ahead of or behind the current scanning orientation of the LiDAR.

Optionally, regulating the operating parameter of the at least one of the wiper or the LiDAR includes: determining the current position of the wiper; and changing the operating parameter of the LiDAR, and the current scanning orientation of the LiDAR is configured to be ahead of or behind the current position of the wiper.

Optionally, the method further includes: controlling the LiDAR to remove point cloud data under a scanning orientation when the predetermined distance is equal to zero.

Optionally, controlling the LiDAR to remove the point cloud data under the scanning orientation when the predetermined distance is equal to zero includes at least one of: controlling the LiDAR not to collect the point cloud data at the current scanning orientation; or controlling the LiDAR to delete the point cloud data collected at the current scanning orientation.

Optionally, the method further includes: controlling the LiDAR to replace the point cloud data under the scanning orientation at the predetermined distance equal to zero with point cloud data in adjacent frames.

In a second aspect, this disclosure further provides a ranging device configured to perform the method for cleaning a window of a LiDAR based on any of the embodiments described above. The ranging device includes: a LiDAR, a communicator and a regulator. The LiDAR is located inside a vehicle cover. A field of view of the LiDAR is configured to form a projection area on the vehicle cover, and a cleaning range of a wiper is configured to at least partially coincide with the projection area. The communicator is configured to communicate with the wiper and the LiDAR. The regulator is configured to regulate operating parameter of the at least one of wiper or the LiDAR to maintain a predetermined distance between a current position of the wiper and a current scanning orientation of the LiDAR.

Optionally, the ranging device further includes an installation device for fixing the LiDAR. The installation device includes: a mount and a plurality of seals. The mount is arranged on an inside of the vehicle cover and configured to fix the LiDAR. The plurality of the seals are installed on the inside of the vehicle cover. The plurality of the seals, the inside of the vehicle cover and the LiDAR form an enclosed space.

Optionally, the seal includes a light-absorbent layer.

Optionally, the vehicle cover includes at least one of a front windscreen or a rear windscreen.

In a third aspect, this disclosure further provides a vehicle configured to perform the method for cleaning a window of a LiDAR based on any of the embodiments described above. The vehicle includes: a vehicle cover, a wiper, a LiDAR, a communicator and a regulator. The LiDAR is located inside the vehicle cover. A field of view of the LiDAR is configured to form a projection area on the vehicle cover, and a cleaning range of the wiper is configured to at least partially coincide with the projection area. The communicator is configured to communicate with the wiper and the LiDAR. The regulator is configured to regulate operating parameter of at least one of the wiper or the LiDAR to maintain a predetermined distance between a current position of the wiper and a current scanning orientation of the LiDAR.

Optionally, a transmittance of the projection area of the vehicle cover to a laser emitted by the LiDAR is greater than a transmittance of areas another area of the vehicle cover.

Optionally, the projection area of the vehicle cover further includes at least one of an anti-reflective coating or a heating wire.

In a fourth aspect, this disclosure provides a method for cleaning a window of a LiDAR for a vehicle. The method includes: regulating an operating parameter of at least one of a wiper of the vehicle or the LiDAR. A cleaning operation of the wiper is configured to cooperate with a detection operation of the LiDAR.

Optionally, the LiDAR is fixed to an inside of a vehicle cover, a field of view of the LiDAR is configured to form a projection area on the vehicle cover, and a cleaning range of the wiper is configured to at least partially coincide with the projection area; and controlling the wiper to perform the cleaning operation.

Optionally, regulating the operating parameter of at least one of the wiper or the LiDAR includes: regulating the operating parameter of the at least one of the wiper or the LiDAR to maintain a predetermined distance between a current position of the wiper and a current scanning orientation of the LiDAR.

Optionally, regulating the operating parameter of the at least one of the wiper or the LiDAR to maintain the predetermined distance between the current position of the wiper and the current scanning orientation of the LiDAR includes: regulating the operating parameter of the at least one of the wiper or the LiDAR, and a time period is within a non-ranging time period of a frame of the LiDAR, and the wiper is configured to wipe across the projection area during the time period.

Optionally, regulating the operating parameter of the at least one of the wiper or the LiDAR to maintain the predetermined distance between the current position of the wiper and the current scanning orientation of the LiDAR further includes: determining whether a duration for the wiper to wipe across the projection area is shorter than or equal to a non-ranging duration of the frame of the LiDAR; and based on a determination that the duration for the wiper to wipe across the projection area is not shorter than or equal to the non-ranging duration of the frame of the LiDAR, changing the operating parameter of the at least one of the wiper or the LiDAR to cause the duration for the wiper to wipe across the projection area to be shorter than or equal to the non-ranging duration of the frame of the LiDAR.

Optionally, changing the operating parameter of the at least one of the wiper or the LiDAR to cause the duration for the wiper to wipe across the projection area to be shorter than or equal to the non-ranging duration of the frame of the LiDAR includes at least one of: accelerating an operating speed of the wiper; or lengthening the non-ranging duration of the frame of the LiDAR; or narrowing a scope of the projection area.

Optionally, lengthening the non-ranging duration of the frame of the LiDAR includes: keeping a frame rate of the LiDAR unchanged and shortening a ranging duration within the frame of the LiDAR; or keeping the ranging duration within the frame of the LiDAR unchanged and reducing the frame rate of the LiDAR; or reducing the frame rate of the LiDAR and shortening the ranging duration within the frame of the LiDAR.

Optionally, regulating the operating parameter of the at least one of the wiper or the LiDAR includes: determining the non-ranging time period of the frame of the LiDAR; determining a first duration for the wiper to enter the projection area; determining a first waiting duration based on the non-ranging time period of the frame of the LiDAR and the first duration, the first waiting duration is a waiting duration before the wiper is started; and controlling the wiper to start after the first waiting period, and the wiper wipes across the projection area during the non-ranging time period of the LiDAR.

Optionally, regulating the operating parameter of the at least one of the wiper or the LiDAR includes: determining a first time period, and the wiper is located within the projection area during the first time period; and changing the operating parameter of the LiDAR, and the non-ranging time period of the LiDAR is configured to coincide with the first time period.

Optionally, regulating the operating parameter of the at least one of the wiper or the LiDAR to maintain the predetermined distance between the current position of the wiper and the current scanning orientation of the LiDAR includes: regulating the operating parameter of the at least one of the wiper or the LiDAR, and the current position of the wiper is ahead of or behind the current scanning orientation of the LiDAR.

Optionally, regulating the operating parameter of the at least one of the wiper or the LiDAR includes: determining the current scanning orientation of the LiDAR; determining the current position of the wiper; determining a second waiting duration based on the current scanning orientation of the LiDAR and the current position of the wiper, the second waiting duration is a waiting duration before the wiper is started; and controlling the wiper to start after the second waiting duration, and the current position of the wiper is ahead of or behind the current scanning orientation of the LiDAR.

Optionally, regulating the operating parameter of the at least one of the wiper or the LiDAR includes: determining the current position of the wiper; and changing the operating parameter of the LiDAR, and the current scanning orientation of the LiDAR is configured to be ahead of or behind the current position of the wiper.

Optionally, the method further includes: controlling the LiDAR to remove point cloud data under a scanning orientation when the predetermined distance is equal to zero.

Optionally, controlling the LiDAR to remove the point cloud data under the scanning orientation when the predetermined distance is equal to zero includes at least one of: controlling the LiDAR not to collect the point cloud data at the current scanning orientation; or controlling the LiDAR to delete the point cloud data collected at the current scanning orientation.

Optionally, the method further includes: controlling the LiDAR to replace the point cloud data under the scanning orientation at the predetermined distance equal to zero with point cloud data in adjacent frames.

In a fifth aspect, this disclosure further provides a ranging device. The ranging device includes: a LIDAR, a communicator and a regulator. The LiDAR is located inside a vehicle cover. A field of view of the LiDAR is configured to form a projection area on the vehicle cover, and a cleaning range of a wiper of a vehicle is configured to at least partially coincide with the projection area. The communicator is configured to communicate with the wiper and the LiDAR. The regulator is configured to regulate operating parameter of at least one of wiper or the LiDAR to maintain a predetermined distance between a current position of the wiper and a current scanning orientation of the LiDAR.

Optionally, the ranging device further includes an installation device for fixing the LiDAR. The installation device includes: a mount and a seal. The mount is arranged on an inside of the vehicle cover and configured to fix the LiDAR. The seal is installed on the inside of the vehicle cover. The seal, the vehicle cover and the LiDAR form an enclosed space.

Optionally, the seal includes a light-absorbent layer.

Optionally, the vehicle cover includes at least one of a front windscreen or a rear windscreen.

In a sixth aspect, this disclosure further provides a vehicle. The vehicle includes: a vehicle cover, a wiper, a LiDAR, a communicator and a regulator. The LiDAR is located inside the vehicle cover. A field of view of the LiDAR is configured to form a projection area on the vehicle cover, and a cleaning range of the wiper is configured to at least partially coincide with the projection area. The communicator is configured to communicate with the wiper and the LiDAR. The regulator is configured to regulate an operating parameter of at least one of the wiper or the LiDAR to maintain a predetermined distance between a current position of the wiper and a current scanning orientation of the LiDAR.

Optionally, a transmittance of the projection area of the vehicle cover to a laser emitted by the LiDAR is greater than a transmittance of areas another area of the vehicle cover.

Optionally, the projection area of the vehicle cover further includes at least one of an anti-reflective coating or a heating wire.

This disclosure provides a method for cleaning the window of the LiDAR for vehicles. The LiDAR is fixed to the inside of the vehicle cover (e.g., the vehicle windshield or vehicle window, or the like), to make a cleaning range of a vehicle's wiper at least partially coincides with the projection area of a field of view of the LiDAR on the vehicle cover. Operating parameter of at least one of the wiper or the LiDAR can be regulated to make a cleaning operation of the wiper and a detection of the LiDAR cooperate with each other, and the wiper can be controlled to perform the cleaning operation. For example, the cooperation between the cleaning operation of the wiper and the detection of the LiDAR can be achieved by controlling to maintain a predetermined distance between the current position of the wiper and the current scanning orientation of the LiDAR. The vehicle cover is used as part of the LiDAR's window, and the wiper is used to clean the LiDAR's window, which has a good cleaning effect. The current position of the wiper can be controlled to maintain a predetermined distance from the current scanning orientation of the LiDAR. By doing so, the LiDAR's window can be cleaned without affecting the normal operation of the LiDAR to ensure the detection performance of the LiDAR.

The operating parameter of the at least one of the wiper or the LiDAR can be regulated such that a time period during which the wiper wipes across the projection area can be within a non-ranging time period of a frame of the LiDAR. By doing so, it can guarantees that the normal operation of the LiDAR can be less affected or not affected when the wiper is in operation, and improves the accuracy of the LiDAR detection results. The implementation mechanism of the method is simple.

The operating parameter of the at least one of the wiper or the LiDAR can be changed such that the duration for the wiper to wipe across the projection area can be shorter than or equal to the non-ranging duration of the frame of the LiDAR. By doing so, it can ensure that the time period during which the wiper wipes across the projection area can be completely within the non-ranging time period of the frame of the LiDAR, which can further ensure that the normal operation of the LiDAR can be less affected or not affected when the wiper is in operation, and improve the accuracy of the LiDAR detection results.

Accelerating the operating speed of the wiper, lengthening the non-ranging duration of the frame of the LiDAR, or narrowing a scope of the projection area, can make the duration for the wiper to wipe across the projection area shorter than or equal to the non-ranging duration of the frame of the LiDAR. By doing so, it can ensure that the time period during which the wiper wipes across the projection area can be completely within the non-ranging time period of the frame of the LiDAR.

Keeping a frame rate of the LiDAR unchanged and shortening a ranging duration within the frame of the LiDAR, or keeping the ranging duration within the frame of the LiDAR unchanged and reducing the frame rate of the LiDAR, or reducing the frame rate of the LiDAR and shortening the ranging duration within the frame of the LiDAR, can lengthen the non-ranging time of the frame of the LiDAR. By doing so, it can ensure that the time period during which the wiper wipes across the projection area can be completely within the non-ranging time period of the frame of the LiDAR.

By determining the non-ranging time period of the frame of the LiDAR and determining a first duration for the wiper to enter the projection area, a first waiting duration can be determined based on the non-ranging time period of the frame of the LiDAR and the first duration. The wiper can be controlled to start after the first waiting time. By controlling the starting time of the wiper, the wiper can be controlled to wipe across the projection area during the non-ranging time period of the LiDAR, and effectively ensuring that the normal operation of the LiDAR can be less affected or not affected when the wiper is in operation, and improving the accuracy of the detection results.

Determine a first time period during which the wiper is located within the projection area, and change the operating parameter of the LiDAR so that the non-ranging time period of the LiDAR can coincide with the first time period. By regulating the non-ranging time period of the LiDAR to coincide with the time during which the wiper wipes across the projection area, it can effectively ensure that the normal operation of the LiDAR can be not affected when the wiper is in operation and the accuracy of the detection results is improved.

The operating parameter of the at least one of the wiper or the LiDAR can be regulated such that the current position of the wiper can be ahead of or behind the current scanning orientation of the LiDAR. By doing so, it can also effectively ensure that the normal operation of the LiDAR can be less affected or not affected when the wiper is in operation, and improve the accuracy of the LiDAR detection results.

By determining the current scanning orientation of the LiDAR and determining the current position of the wiper, a second waiting duration can be determined based on the current scanning orientation of the LiDAR and the current position of the wiper. The wiper can be controlled to start after the second waiting duration, which can make the current position of the wiper ahead of or behind the current scanning orientation of the LiDAR. Accordingly, the current scanning orientation of the LiDAR can be less affected or not blocked by the wiper. By doing so, it can effectively ensure that the normal operation of the LiDAR can be less affected or not affected when the wiper is in operation and improve the accuracy of the LiDAR detection results.

Determining the current position of the wiper and changing the operating parameter of the LiDAR such that the current scanning orientation of the LiDAR can be ahead of or behind the current position of the wiper. By doing so, it can effectively ensure that the normal operation of the LiDAR can be less affected or not affected when the wiper is in operation, and improve the accuracy of the LiDAR detection results.

By controlling the LiDAR to remove point cloud data under a scanning orientation when the predetermined distance is equal to zero, the impact of blocking by the wiper on the detection results of the LiDAR can be effectively reduced or avoided, which can improve the accuracy of the LiDAR detection results, and is easy to implement.

When the predetermined distance is equal to zero (e.g., when the wiper blocks the current scanning orientation of the LiDAR), the LiDAR can be controlled not to collect point cloud data at the current scanning orientation, or the LiDAR can be controlled to delete the point cloud data collected at the current scanning orientation, the point cloud data at the scanning orientation when the predetermined distance is equal to zero can be removed. By doing so, it can effectively reduce or avoid the impact of the wiper on the LiDAR detection results.

By controlling the LiDAR to replace the point cloud data at the scanning orientation when the predetermined distance is equal to zero with point cloud data in adjacent frames, the impact of the wiper on the LiDAR detection results can be effectively reduced or avoided, and the integrity of the output point cloud data can be improved or ensured.

### BRIEF DESCRIPTION OF THE DRAWINGS

For the sake of explaining the embodiments of this disclosure more clearly, the drawings needed to be used in the description of the embodiments is introduced below. It is apparent that the drawings in the following description are merely embodiments of this disclosure. Other drawings can be obtained by those of ordinary skill in the art based on the provided drawings without creative efforts.

FIG. 1 shows a flow chart of an example method for cleaning a window of a LiDAR for vehicles, consistent with some embodiments of this disclosure.

FIG. 2 shows a schematic diagram of an example detection time of a LiDAR, consistent with some embodiments of this disclosure.

FIG. 3 shows a schematic diagram of an example method for lengthening the non-ranging time of the frame of the LiDAR, consistent with some embodiments of this disclosure.

FIG. 4a shows a schematic diagram of an example projection area formed by the field of view of a LiDAR on a vehicle cover, consistent with some embodiments of this disclosure.

FIG. 4b shows a schematic diagram of another example projection area formed by the field of view of a LiDAR on a vehicle cover, consistent with some embodiments of this disclosure.

FIG. 5 shows a schematic diagram of a range of wiper scanning angles corresponding to an example projection area, consistent with some embodiments of this disclosure.

FIG. 6 shows a first example flow chart for regulating an operating parameter of a wiper or a LiDAR, consistent with some embodiments of this disclosure.

FIG. 7 shows a second example flow chart for regulating an operating parameter of a wiper or a LiDAR, consistent with some embodiments of this disclosure.

FIG. 8a shows a schematic top view of an example operation process of a LiDAR and a wiper, consistent with some embodiments of this disclosure.

FIG. 8b shows a schematic top view of another example operation process of a LiDAR and a wiper, consistent with some embodiments of this disclosure.

FIG. 9 shows a third example flow chart for regulating an operating parameter of a wiper or a LiDAR, consistent with some embodiments of this disclosure.

FIG. 10 shows a fourth example flow chart for regulating an operating parameter of a wiper or a LiDAR, consistent with some embodiments of this disclosure.

FIG. 11 shows a schematic structural diagram of an example ranging device, consistent with some embodiments of this disclosure.

FIG. 12 shows a schematic diagram of the installation and position of an example ranging device, consistent with some embodiments of this disclosure.

FIG. 13 shows a schematic side view of the installation and position of an example ranging device, consistent with some embodiments of this disclosure.

### DETAILED DESCRIPTION

Additional cleaning devices are usually equipped to clean LiDARs in the existing technology. However, additionally equipped cleaning devices can have less-than-ideal cleaning effect and high cost. In addition, the appearance of the passenger car can be affected.

Embodiments of this disclosure provide a method for cleaning a window of a LiDAR for vehicles. The LiDAR can be fixed to an inside of a vehicle cover (e.g., a windshield or vehicle window of the vehicle, or the like). By doing so, the cleaning range of the vehicle's wiper can at least partially coincide with an area of a field of view (“FOV”) of the LiDAR projected onto the vehicle cover. By regulating the operating parameter of the wiper or the LiDAR, the cleaning operation of the wiper and the detection of the LiDAR can cooperate with each other, and the wiper can be controlled to perform cleaning operations. The vehicle cover can be used as part of the LiDAR window, and the wiper can be used to clean the LiDAR window. By doing so, a good cleaning effect can be achieved. The current position of the wiper can be controlled to maintain a predetermined distance from the current scanning orientation of the LiDAR. By doing so, the LiDAR's window can be cleaned without affecting the normal operation of the LiDAR, and the detection performance of the LiDAR can be ensured.

The concepts, solutions, principles, and advantages of embodiments of this disclosure are described in detail below with reference to the accompanying drawings and through application examples.

Consistent with some embodiments of this disclosure, a method for cleaning a window of a LiDAR for vehicles is provided. The LiDAR can be fixed to an inside of a vehicle cover. A field of view of the LiDAR can form a projection area on the vehicle cover, and a cleaning range of a wiper can at least partially coincide with the projection area. The cleaning method can be suitable for cleaning occlusions within the field of view of the LiDAR.

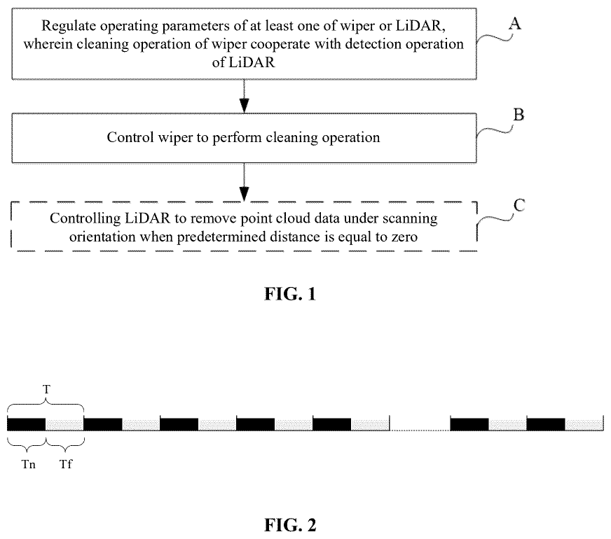

FIG. 1 shows a flow chart of an example method for cleaning a window of a LIDAR for vehicles, consistent with some embodiments of this disclosure. Referring to FIG. 1, in some embodiments, the following steps can be implemented to clean the window of the LiDAR for vehicles.

At step A, an operating parameter of at least one of the wiper or the LiDAR can be regulated to cause a cleaning operation of the wiper to cooperate with a detection operation of the LiDAR. For example, the wiper and the LiDAR can be connected to a controller via a communication interface. The operating parameter of the at least one of the wiper or the LiDAR can be regulated by the controller.

For example, at step A, the operating parameter of the at least one of the wiper or the LiDAR can be regulated to maintain a predetermined distance between a current position of the wiper and a current scanning orientation of the LiDAR.

In some embodiments, the current position of the wiper can be a position of the wiper in a LIDAR coordinate system. The current scanning orientation of the LiDAR can be a position of the current scanning angle in a projection area (e.g., formed by a FOV of the LiDAR on a vehicle cover) in the LiDAR coordinate system. The predetermined distance can be a minimum distance between the position of the current scanning angle of the LiDAR in the projection area and the current position of the wiper in the LiDAR coordinate system.

In some embodiments, the predetermined distance can be a specific value or a range. For example, the predetermined distance can be 0.1 cm, 0.5 cm, 1 cm, 5 cm, 10 cm, 20 cm, or the like. For another example, the predetermined distance can be any distance greater than 0.1 cm. In some embodiments, the value or the range of the predetermined distance can be changed. For example, the predetermined distance can be changed from 1 cm to 2 cm. For another example, the predetermined distance can be changed from 1 cm to any distance greater than 1 cm.

In some embodiments, a communication interface can also be provided between the LiDAR and the wiper. By doing so, the LiDAR and the wiper can communicate (e.g., directly or indirectly) to regulate the operating parameter of the at least one of the wiper or the LiDAR. For example, the wiper and LiDAR can be directly connected via the communication interface. The LiDAR can obtain control data and position data of the wiper. The LiDAR can also change its operating parameter to maintain a predetermined distance between the current scanning orientation of the LiDAR and the current position of the wiper. For another example, the wiper can obtain operational data (e.g., scanning data) of the LiDAR. The wiper can also change its operating parameter to maintain the predetermined distance between the current position of the wiper and the current scanning orientation of the LiDAR.

It can be understood that the embodiments of this disclosure do not place any restrictions on the embodiments of regulating the operating parameter of the wiper or the LiDAR, as long as the operating parameter of the wiper or the LiDAR can be regulated.

Still referring to FIG. 1, at step B, the wiper can be controlled to perform a cleaning operation. For example, the wiper can be connected to a controller via a communication interface. The wiper can be controlled to perform a cleaning operation by the controller.

In some embodiments, the cleaning operation of the wiper can cooperate with the detection of the LiDAR. A predetermined distance can be maintained between the wiper and the current scanning orientation of the LiDAR during the cleaning operation. By doing so, the normal operation of the LiDAR can be less affected or not affected by the wiper, and the detection performance of the LiDAR can be ensured.

In some embodiments, the LiDAR can be arranged inside the vehicle cover (e.g., a front windshield, a rear windshield, a vehicle window, or the like), and the vehicle cover can be used as a part of the window of the LiDAR. The vehicle cover can cleaned to achieve a better effect of cleaning the window of the LiDAR. Regulating the operating parameter of the wiper or the LiDAR can cause the cleaning operation of the wiper to cooperate with the detection operation of the LiDAR. A predetermined distance can be maintained between the current position of the wiper and the current scanning orientation of the LiDAR. The wiper can be controlled to perform a cleaning operation. By doing so, the LiDAR's window can be cleaned without affecting the normal operation of the LiDAR, and the detection performance of the LiDAR can be ensured.

In some embodiments, as an example for step A, the operating parameter of the wiper or the LiDAR can be changed such that a time period during which the wiper wipes across the projection area can be within a non-ranging time period of a frame of the LiDAR.

FIG. 2 shows a schematic diagram of an example detection time of a LiDAR, consistent with some embodiments of this disclosure. For example, referring to FIG. 2, T represents the total duration of a frame of the LiDAR, and the total duration of a frame includes a ranging time period Tn and a non-ranging time period Tf. The non-ranging time period Tf refers to the time period during which the LiDAR does not collect point cloud data. For example, for a LiDAR that uses a multi-facet rotating mirror for scanning, the LiDAR can scan the field of view with a mirror on any facet of the multi-facet rotating mirror. When the multi-facet rotating mirror rotates, the LiDAR does not collect point cloud data when any two adjacent mirrors are switched, and such a time period is the non-ranging time period Tf. As another example, a LiDAR that uses a galvanometer or a swing mirror for scanning can stop for a period of time at the maximum swing amplitude of the galvanometer or swing mirror. During this time period, the LiDAR does not collect point cloud data, and such a time period is the non-ranging time period Tf. As another example, there can be a time interval between collecting data of any two frames by a solid-state LiDAR. During this time interval, the LiDAR does not collect point cloud data, and such a time interval is the non-ranging time period Tf. Similarly, other types of the LiDAR can have non-ranging time periods in which data is not being collected.

In some embodiments, the operating parameter of the wiper or the LiDAR can be regulated, and the cleaning operation of the wiper and the detection of the LiDAR can be synchronized. By doing so, the time period during which the wiper wipes across the projection area can be within the non-ranging time period Tf of the frame of the LiDAR. The point cloud image of the LiDAR can be less affected or not affected. Therefore, the LiDAR window can be cleaned without affecting the normal operation of the LiDAR, and the detection performance of the LiDAR can be ensured.

In some embodiments, when the LiDAR is in the non-ranging time period Tf, it can be considered that the predetermined distance between the current position of the wiper and the current scanning orientation of the LiDAR is infinite.

In some embodiments, some operations can be performed so that the time period during which the wiper wipes across the projection area is within the non-ranging time period of the frame of the LiDAR. By doing so, it can ensure that the time period during which the wiper wipes across the projection area can be within the non-ranging time period Tf of the frame of the LiDAR, and the accuracy of the LiDAR detection results can be further improved. For example, whether a duration for the wiper to wipe across the projection area is shorter than or equal to a non-ranging duration of the frame of the LiDAR can be determined. When the duration for the wiper to wipe across the projection area is not shorter than or equal to the non-ranging duration of the frame of the LiDAR, the operating parameter of at least one of the wiper or the LiDAR can be changed to cause the duration for the wiper to wipe across the projection area to be shorter than or equal to the non-ranging duration of the frame of the LiDAR. The non-ranging duration of the frame of the LiDAR can be the duration of the non-ranging time period Tf of the frame of the LiDAR.

In some embodiments, the duration for the wiper to wipe across the projection area can be greater than the non-ranging duration of the frame of the LiDAR. In this case, the time period during which the wiper wipes across the projection area cannot be completely within the non-ranging time period of the frame of the LiDAR. In some embodiments, the operating parameter of the wiper or the LiDAR can be changed such that the duration for the wiper to wipe across the projection area can be shorter than or equal to the non-ranging duration of the frame of the LiDAR. By doing so, it is possible to achieve that the time period during which the wiper wipes across the projection area can be within the non-ranging time period of the frame of the LiDAR. Further, by synchronizing the cleaning operation of the wiper and the detection operation of the LiDAR, the time period when the wiper wipes across the projection area can be within the non-ranging time period of the frame of the LiDAR, so that it can be further improved or ensured that the normal operation of the LiDAR can be less affected or not affected when the wiper is in operation, improving the accuracy of the LiDAR detection results.

To enable those skilled in the art to better understand and implement, descriptions about some example methods for changing different operating parameter of the wiper or the LiDAR so that the duration for the wiper to wipe across the projection area can be shorter than or equal to the non-ranging duration of the frame of the LiDAR are given in the following, in combination with some examples.

In some embodiments, the operating speed of the wiper can be accelerated so that the duration for the wiper to wipe across the projection area can be shorter than or equal to the non-ranging duration of the frame of the LiDAR.

For example, the operating angular speed of the wiper can be accelerated to shorten the duration for the wiper to wipe across the projection area. By doing so, the duration for the wiper to wipe across the projection area can be shorter than or equal to the non-ranging duration of the frame of the LiDAR.

In some other embodiments, still referring to FIG. 2, the non-ranging time of the frame of the LiDAR can be lengthened, so that the time for the wiper to wipe across the projection area can be shorter than or equal to the non-ranging duration of the frame of the LiDAR.

In some embodiments, the ranging duration within the frame of the LiDAR can be shortened while keeping the frame rate of the LiDAR unchanged. By doing so, the non-ranging duration of the frame of the LiDAR can be lengthened.

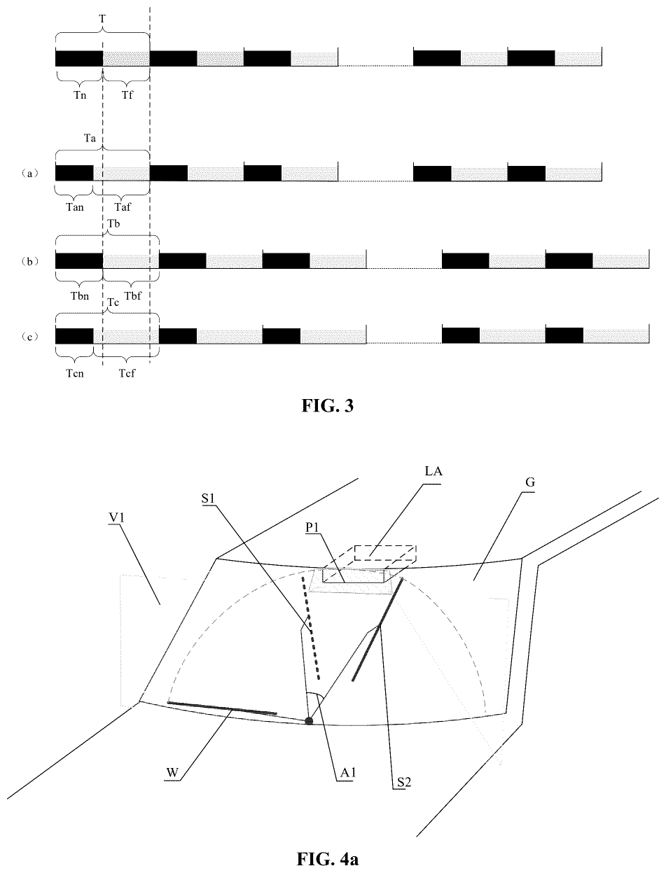

For example, the frame can be a scanning frequency of the field of view by the LiDAR. In some embodiments, the scanning frequency can be the number of times the field of view can be scanned in 1 second. The higher the frame rate, the higher the scanning frequency of the LiDAR can be. FIG. 3 shows a schematic diagram of an example method for lengthening the non-ranging time of the frame of the LiDAR, consistent with some embodiments of this disclosure. For example, referring to FIG. 3, T represents the total duration of a frame of the LiDAR, and the total duration of a frame includes the ranging time period Tn and the non-ranging time period Tf. For example, referring to subfigure (a) of FIG. 3, the frame rate of the LiDAR can be unchanged (e.g., the number of times the LiDAR scans the field of view per second remains unchanged), and the total duration of each frame of the LiDAR can remain unchanged (e.g., Ta=T). The ranging duration within the frame of the LiDAR can be shorten (e.g., making Tan<Tn). By doing so, the non-ranging time of the frame of the LiDAR can be lengthened, where Taf can be greater than Tf.

In some embodiments, the ranging duration within the frame of the LiDAR can be unchanged. By doing so, the non-ranging time of the frame of the LiDAR can be lengthened, and the frame rate of the LiDAR can also be reduced.

For example, referring to subfigure (b) of FIG. 3, the frame rate of the LiDAR can be reduced (e.g., reduce the number of times the LiDAR scans the field of view per second). The ranging duration within the frame of the LiDAR can be unchanged (e.g., Tbn=Tn). By doing so, the total duration of each frame of the LiDAR becomes longer (e.g., Tb>T), and the non-ranging time of the frame of the LiDAR can be lengthened (e.g., Tbf>Tf).

In some embodiments, the non-ranging time of the frame of the LiDAR can also be lengthened by reducing the frame rate of the LiDAR and shortening the ranging duration within the frame of the LiDAR.

For example, referring to subfigure (c) of FIG. 3, the ranging duration within the frame of the LiDAR can be shortened while reducing the frame rate of the LiDAR (e.g., Tc>T and Tcf>Tf). By doing so, the non-ranging time of the frame of the LiDAR can be lengthened (e.g., Tcf>Tf).

Consistent with embodiments of this disclosure, any of the above methods can increase the non-ranging duration of the LiDAR, thereby leaving enough time for the wiper to wipe across the projection area, so that the normal operation of the LiDAR can be less affected or not affected as the wiper cleans the LiDAR window. It should be noted that the vehicle driver can actively change the wiper's swing rate to meet its applicable needs due to changes in the environment. When a change in the wiper's swing rate is detected, it can make the above determination on whether the duration for the wiper wipe across the projection area is shorter than or equal to the non-ranging duration of the frame of the LiDAR again, and complete the synchronization of the wiper and LiDAR again.

In some embodiments, the scope of the projection area can be narrowed so that the duration for the wiper to wipe across the projection area can be shorter than or equal to the non-ranging duration of the frame of the LiDAR.

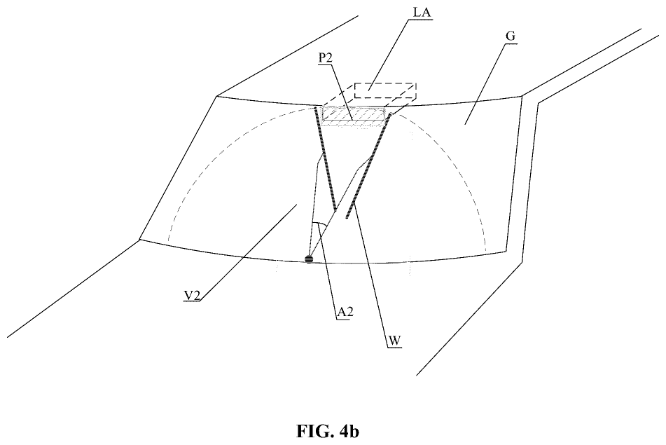

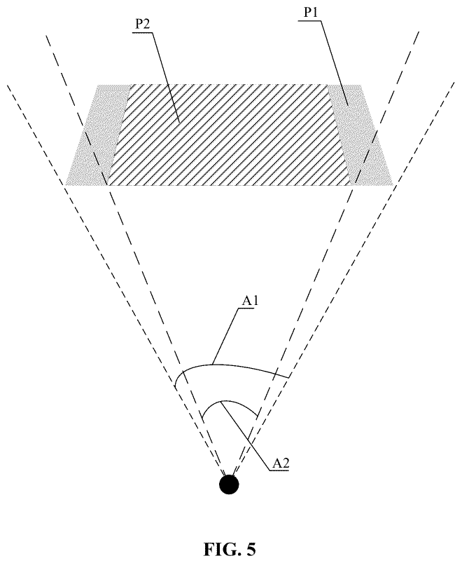

FIG. 4a shows a schematic diagram of an example projection area formed by the LiDAR's field of view on the vehicle cover, consistent with some embodiments of this disclosure. FIG. 4b shows a schematic diagram of another example projection area formed by the field of view of a LiDAR on a vehicle cover, consistent with some embodiments of this disclosure. FIG. 5 shows a schematic diagram of a range of wiper scanning angles corresponding to an example projection area, consistent with some embodiments of this disclosure. For example, referring to FIG. 4a to FIG. 5, passenger cars can achieve assisted driving or autonomous driving by setting up a LiDAR LA. In some embodiments, the LiDAR can be fixed to the inside of the vehicle cover. The field of view of the LiDAR can form a projection area on the vehicle cover. The cleaning range of the wiper can at least partially coincide with the projection area. As shown in FIG. 4a, before changing the field of view of the LiDAR LA (e.g., before changing the scope of the projection area), P1 represents the projection area formed by the field of view V1 of the LiDAR LA on the vehicle cover G, where the horizontal field of view of the LiDAR LA can be 120°. Taking a rotating-mirror LiDAR as an example, its frame rate can be 10 Hz (e.g., the total duration of each frame can be 100 ms). Each frame can include a ranging time period and a non-ranging time period. The ranging time period can be 50 ms during which the LiDAR collects data, and the non-ranging time period (e.g., the non-ranging duration) can be 50 ms during which the LiDAR does not collect data. When the wiper W wipes across the projection area P1 within 50 ms of the non-ranging time period, the normal operation of the LiDAR LA can be unaffected.

In some embodiments, a car wiper can take 1 second to complete a round-trip wipe at the maximum gear (e.g., fastest operating speed), with a one-way time of 500 ms and a one-way operating angle of about 120°. For example, referring to FIG. 4a, when the wiper running at the maximum gear, it can take 300 ms to run at a constant speed and take 200 ms to change the direction at one end. The angle range A1 of the wiper corresponding to the projection area P1 can be 30°. The duration for the wiper W to wipe across the projection area P1 can be 75 ms (e.g., 300 ms*30°/120°=75 ms). Therefore, the time for the wiper to wipe across the projection area can be greater than the non-ranging duration of the LiDAR. In this case, the LiDAR can be blocked when the wiper wipes across the projection area, and affecting the data collection of the LiDAR. The time for the wiper to wipe across the projection area can be reduced by reducing the scope of the projection area. For example, the range of the field of view of the LiDAR LA can be changed. Referring to FIGS. 4a and 4b, the scope of the projection area can be reduced by reducing the horizontal field of view of the LiDAR. It should be noted that if the wiper W is disposed on the side of the vehicle cover G, and the wiper W swings up and down, the scope of the projection area can be reduced by reducing the vertical field of view. The wiper W can be disposed at any positions and orientations, and the scope of the projection area can be reduced by a similar manner without limitation in this disclosure.

The above examples are described based on the horizontal field of view of the LiDAR LA of 120°. In some embodiments, the horizontal field of view of the LiDAR LA can be changed to be 80°, thereby reducing the scope of the projection area so that the duration for the wiper wipes across the projection area can be shorter than or equal to the non-ranging duration of the frame of the LiDAR.

For example, continuing to refer to FIGS. 4b and 5, P2 represents the projection area formed by the field of view V2 of the LiDAR LA with the vehicle cover G, where the horizontal field of view of the LiDAR LA is 80°. When the frame rate remains unchanged, the ranging time period of the LiDAR can be reduced to 33.4 ms, and the non-ranging time period of the LiDAR LA increases from 50 ms to 66.6 ms (e.g., 100 ms−50 ms*80°/120°=66.6 ms). The angle range A2 of the wiper corresponding to the projection area P2 can be reduced from 30° to about 20°, and the duration for the wiper W to wipe across the projection area P2 can be 50 ms (e.g., 300 ms*20°/120°=50 ms). The duration (e.g., 50 ms) for the wiper W to wipe across the projection area P2 can be shorter than the non-ranging time period (e.g., 66.6 ms) of the LiDAR LA. In such a case, the duration for the wiper to wipe across the projection area can be shorter than or equal to the non-ranging duration of the frame of the LiDAR. It should be noted that the above duration and angle data only illustrate that reducing the scope of the projection area can make the duration for the wiper wipes across the projection area shorter than or equal to the non-ranging duration of the frame of the LiDAR, and do not represent the limitations to actual application of the solution of this disclosure.

The following describes some example methods for regulating the operating parameter of the wiper or LiDAR so that the time period during which the wiper wipes across the projection area can be within the non-ranging time period of the frame of the LiDAR.

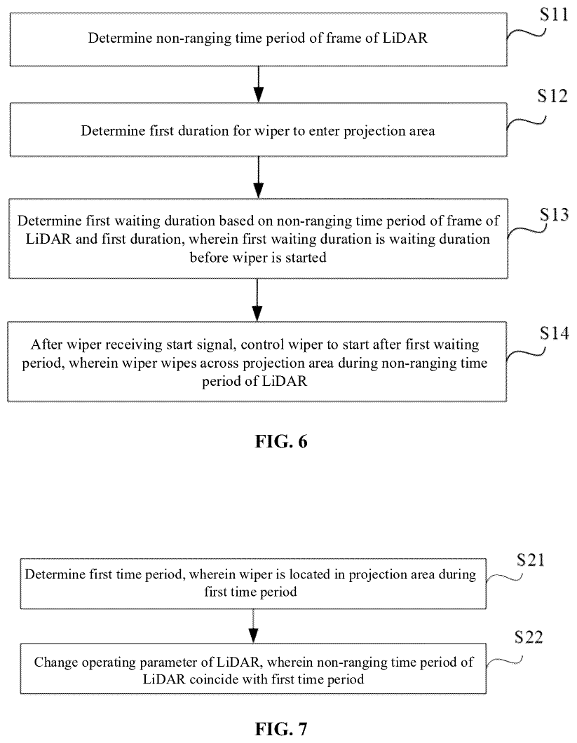

FIG. 6 shows a first example flow chart for regulating an operating parameter of a wiper or a LiDAR, consistent with some embodiments of this disclosure. In some embodiments, with reference to FIG. 6, the following steps can be implemented to change the operating parameter of at least one of the wiper or the LiDAR to synchronize the cleaning operation of the wiper with the detection operation of the LiDAR. By doing so, the time period during which the wiper wipes across the projection area can be within the non-ranging time period of the frame of the LiDAR.

At step S11, the non-ranging time period of the frame of the LiDAR can be determined. For example, the LiDAR can be connected to a controller via a communication interface. The non-ranging time period of the frame of the LiDAR can be determined by the controller.

For example, reference can be made to the foregoing embodiments for relevant descriptions about the non-ranging time period of the frame of the LiDAR.

At step S12, a first duration for the wiper to enter the projection area can be determined. For example, the wiper can be connected to a controller via a communication interface. A first duration for the wiper to enter the projection area can be determined by the controller.

For example, still referring to FIG. 4a, when the wiper is at a position S1, it is deemed that the wiper has entered the projection area. The time taken to run from the starting position of the wiper to the position S1 can be the first duration for the wiper to enter the projection area.

In some embodiments, for example, the starting position of the wiper can be fixed, the positional relationship between the wiper and the projection area and the operating speed of the wiper can be predetermined. The first duration for the wiper to enter the projection area can be determined based on the three foregoing factors. For another example, an angle sensor can be disposed to obtain the starting position of the wiper, and the operating speed of the wiper and the position at which the wiper enters the projection area can be determined. The first duration for the wiper to enter the projection area can be obtained based on the three factors.

At step S13, a first waiting duration can be determined based on the non-ranging time period of the frame of the LiDAR and the first duration. The first waiting duration can be a waiting duration before the wiper is started. For example, the LiDAR and the wiper can be connected to a controller via a communication interface. A first waiting duration can be determined by the controller based on a non-ranging time period of the frame of the LiDAR and a first duration of the wiper.

At step S14, in response to a start signal received by the wiper, the wiper can be controlled to start after the first waiting duration, and the wiper can wipe across the projection area during the non-ranging time period of the LiDAR. For example, the wiper can be connected to a controller via a communication interface. In response to a start signal received by the wiper, the wiper can be controlled to star after the first waiting duration. Accordingly, the wiper can wipe across the projection area during the non-ranging time period of the LiDAR.

In some embodiments, the non-ranging time period of the frame of the LiDAR and the first duration for the wiper to enter the projection area can be determined. The first waiting duration can be determined based on the non-ranging time period of the frame of the LiDAR and the first duration. The wiper can be controlled to start after the first waiting duration so that the wiper can wipe across the projection area during the non-ranging time period of the LiDAR. Doing so can effectively ensure that the normal operation of the LiDAR can be less affected or not affected when the wiper is in operation, and can improve the accuracy of the LiDAR detection results. The wiper can be directly controlled to start after the first waiting duration. In some embodiments, the ranging time and non-ranging time of each frame of the LiDAR can be both in the order of milliseconds. In some embodiments, the first waiting duration can be in the order of milliseconds. In some embodiments, the waiting time of wiper can be short with little or no impact on the user experience.

Consistent with embodiments of this disclosure, after the steps S11 to S14 have been completed, when the vehicle's driver changes the speed of the wiper due to changes in the environment, the step S12 can further include the following steps, after changing the speed of the wiper.

At step S121, the wiper can swing to an edge position and stop swinging.

At step S122, the first duration for the wiper to enter the projection area from the edge position can be determined. For example, the wiper can be connected to a controller via a communication interface. A first duration for the wiper to enter the projection area from the edge position can be determined by the controller.

For example, the edge position can be a position where the wiper changes the swing direction. In some embodiments, the edge position can be the starting position of the wiper.

FIG. 7 shows a second example flow chart for regulating an operating parameter of a wiper or a LiDAR, consistent with some embodiments of this disclosure. In some other embodiments of this disclosure, with reference to FIG. 7, the following steps can also be implemented to change the operating parameter of the wiper or LiDAR so that the time period during which the wiper wipes across the projection area can be within the non-ranging time period of the frame of the LiDAR.

At step S21, the first time period can be determined. During the first time period, the wiper can be located in the projection area. For example, the wiper can be connected to a controller via a communication interface. A first time period for the wiper to located in the projection area can be determined by the controller.

For example, referring back to FIG. 4a, when the wiper is at the position S1, it can be deemed that the wiper has entered the projection area. When the wiper is at a position S2, it can be deemed that the wiper has left the projection area. The time for the wiper to move from the position S1 to the position S2 is the first time period during which the wiper is located in the projection area.

In some embodiments, the time when the wiper enters the projection area and the time when the wiper leaves the projection area can be determined based on the starting position of the wiper, the positional relationship between the wiper and the projection area, and the operating speed of the wiper. By doing so, the first time period during which the wiper is located within the projection area can be determined.

In some embodiments, the position of the wiper can also be determined by means of an angle sensor. The positional relationship between the wiper and the projection area can be known. The time when the wiper enters the projection area and the time when the wiper leaves the projection area can be determined by means of the angle sensor, and the first time period during which the wiper is located in the projection area can be determined.

In some other embodiments, the time when the wiper enters the projection area and the time when the wiper leaves the projection area can also be determined based on the obtained point cloud data, and then the first time period during which the wiper is located in the projection area can be determined. For example, after the start signal for the wiper is received, in a frame, the time when the point cloud of the wiper appears in the field of view of the LiDAR can be the time when the wiper enters the projection area, and the time when point cloud of the wiper disappears in the field of view of the LiDAR can be the time when the wiper leaves the projection area.

At step S22, the operating parameter of the LiDAR can be changed, and the non-ranging time period of the LiDAR can coincide with the first time period. For example, the LiDAR can be connected to a controller via a communication interface. The operating parameter of the LiDAR can be changed by the controller.

For example, because the wiper can swing regularly and periodically, the first time period can also be regular. By changing the rotation speed or phase of the motor of the LiDAR based on the first time period during which the wiper is located in the projection area, the non-ranging time period of the LiDAR can be made to coincide with the first time period.

In some embodiments, the first time period during which the wiper is located in the projection area can be determined, and the operating parameter of the LiDAR can be changed. By doing so, the non-ranging time period of the LiDAR can coincide with the first time period, which can effectively ensure that the normal operation of the LiDAR can be less affected or not affected when the wiper is in operation, and improving the accuracy of the LiDAR detection results. This method can be implemented by setting a corresponding control algorithm inside the LiDAR, or an additional control unit can be provided to control the LiDAR to change parameters.

In some embodiments, after completing the steps S21 to S22, the vehicle's driver can change the speed of the wiper due to changes in the environment. After the speed of the wiper is changed, the first time period during which the wiper is located in the projection area can be determined again, and the operating parameter of the LiDAR can be changed again so that the non-ranging time period of the LiDAR can coincide with the first time period.

In some embodiments, as an optional example for step A, to maintain a predetermined distance between the current position of the wiper and the current scanning orientation of the LiDAR, the operating parameter of the wiper or the LiDAR can be regulated such that the current position of the wiper can be ahead of or behind the current scanning orientation of the LiDAR.

For example, when scanning to the current scanning angle, the LiDAR can collect point cloud data of the current scanning angle. The operating parameter of the wiper or the LiDAR can be regulated such that the current position of the wiper can be ahead of or behind the current scanning orientation of the LiDAR. By doing so, it can be effectively improved or ensured that the normal operation of the LiDAR can be less affected or not affected when the wiper is in operation, and improving the accuracy of the LiDAR detection results. For some LiDARs that have no non-ranging time period, or have a very short non-ranging time period (e.g., which cannot meet the time requirement of the wiper to wipe across the projection area), the method of this disclosure can also clean the window of the LiDAR with little or no affect on the normal operation of the LiDAR.

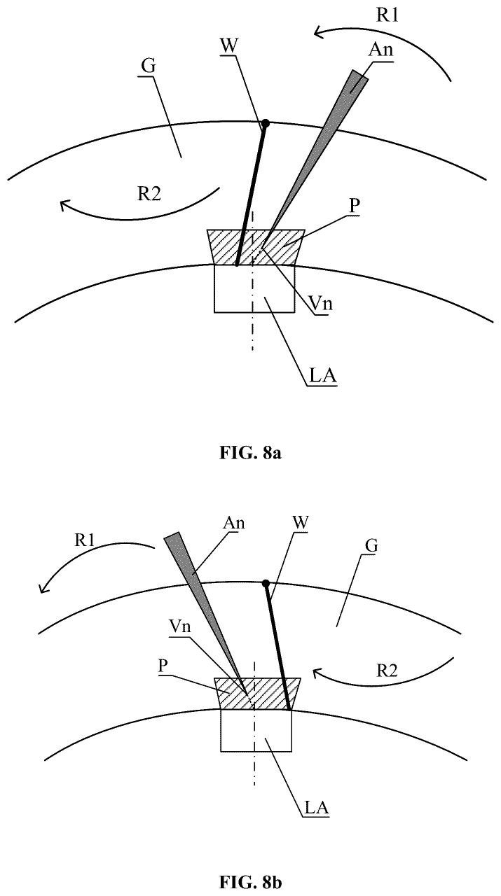

In some embodiments, the LiDAR for vehicles can scan in the horizontal direction such as a rotating mirror LiDAR or an electronic scanning LiDAR. FIG. 8a shows a schematic top view of an example operation process of a LiDAR and a wiper, consistent with some embodiments of this disclosure. FIG. 8b shows a schematic top view of another example operation process of a LiDAR and a wiper, consistent with some embodiments of this disclosure. FIG. 9 shows a third example flow chart for regulating an operating parameter of a wiper or a LiDAR, consistent with some embodiments of this disclosure. For case of understanding, the operation process of the LiDAR and the wiper in FIGS. 8a to 8b are illustrated by a partial top view of the LiDAR and the wiper below. For example, referring to FIG. 4a, FIG. 4b, FIG. 8a, FIG. 8b and FIG. 9, the LiDAR LA scans in the direction R1. The wiper W moves in the direction R2. A predetermined distance between the current position of the wiper and the current scanning orientation Vn of the LiDAR (e.g., the position of the current scanning angle An of the LiDAR LA in the projection area P) can be maintained. The current position of the wiper is ahead of the current scanning orientation Vn of the LiDAR. It can be seen from FIG. 8b that the current position of the wiper is behind the current scanning orientation Vn of the LiDAR. For example, still referring to FIG. 9, the following steps can be implemented to change the operating parameter of the wiper or LiDAR so that the current position of the wiper can be ahead of or behind the current scanning orientation of the LiDAR.

At step S31, the current scanning orientation of the LiDAR can be determined. For example, the LiDAR can be connected to a controller via a communication interface. A current scanning orientation of the LiDAR can be determined by the controller.

At step S32, the current position of the wiper can be determined. For example, the wiper can be connected to a controller via a communication interface. A current position of the wiper can be determined by the controller.

In some embodiments, the current position of the wiper can be determined by means of an angle sensor.

At step S33, a second waiting duration can be determined based on the current scanning orientation of the LiDAR and the current position of the wiper. The second waiting duration can be a waiting duration before the wiper is started. For example, the LiDAR and the wiper can be connected to a controller via a communication interface. A second waiting duration can be determined by the controller based on the current scanning orientation of the LiDAR and the current position of the wiper.

At step S34, in response to the wiper receives a start signal, the wiper can be controlled to start after the second waiting duration, and the current position of the wiper can be ahead of or behind the current scanning orientation of the LiDAR. For example, the wiper can be connected to a controller via a communication interface. In response to the wiper receives a start signal, the wiper can be controlled to start after the second waiting duration by the controller. Accordingly, the current position of the wiper can be ahead of or behind the current scanning orientation of the LiDAR.

In some embodiments, the current scanning orientation of the LiDAR and the current position of the wiper can be determined. The second waiting duration can be determined based on the current scanning orientation of the LiDAR and the current position of the wiper. The wiper can be controlled to start after the second waiting duration to make the current position of the wiper ahead of or lag behind the current scanning orientation of the LiDAR. By doing so, it can reduce or prevent the wiper block the current scanning orientation of the LiDAR, and effectively ensuring that the normal operation of the LiDAR can be less affected or not affected when the wiper is in operation and improving the accuracy of the LiDAR detection results.

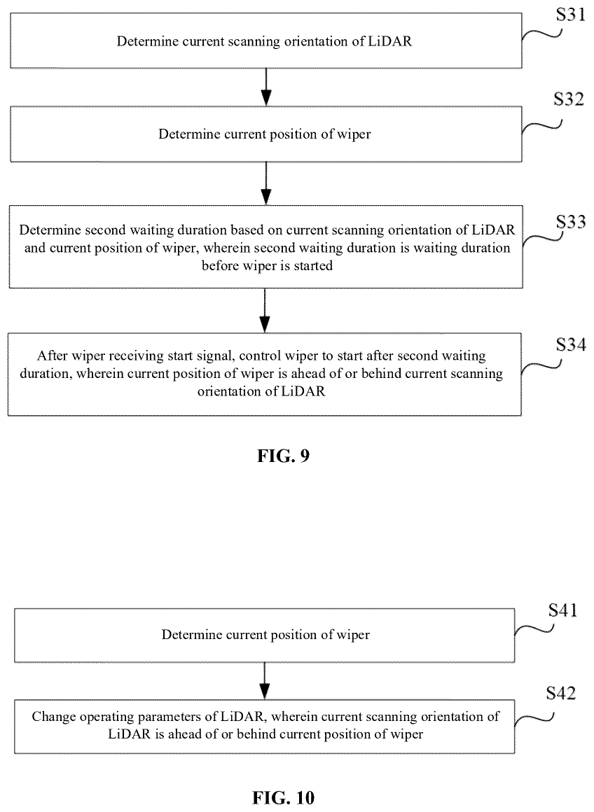

FIG. 10 shows a fourth example flow chart for regulating an operating parameter of a wiper or a LiDAR, consistent with some embodiments of this disclosure. In some other embodiments of this disclosure, referring to FIG. 10, the following steps can also be implemented to change the operating parameter of the wiper or LiDAR such that the current position of the wiper can be ahead of or behind the current scanning orientation of the LiDAR.

At step S41, the current position of the wiper can be determined. For example, the wiper can be connected to a controller via a communication interface. A current position of the wiper can be determined by the controller.

At step S42, the operating parameter of the LiDAR can be changed, and the current scanning orientation of the LiDAR can be ahead of or behind the current position of the wiper. For example, the LiDAR can be connected to a controller via a communication interface. An operating parameter of the LiDAR can be changed by the controller. Accordingly, the current scanning orientation of the LiDAR can be ahead of or behind the current position of the wiper.

For example, the rotation speed or phase of the motor of the LiDAR can be changed based on the current position of the wiper to make the current position of the wiper ahead of or behind the current scanning orientation of the LiDAR.

In some embodiments, the current position of the wiper can be determined, and the operating parameter of the LiDAR can be changed so that the current scanning orientation of the LiDAR can be ahead of or behind the current position of the wiper. By doing so, it can effectively ensure that the normal operation of the LiDAR can be less affected or not affected when the wiper is in operation and improving the accuracy of the LiDAR detection results.

In some embodiments, the LiDAR for vehicles can be a galvanometer LiDAR, a flash LiDAR, or any LiDAR that do not scan in the horizontal direction. In some embodiments, the LiDAR for vehicles can be a rotating mirror LiDAR that scans in the vertical direction. In some embodiments, the wiper can block the current scanning orientation of the LiDAR. For example, referring back to FIG. 1, the method for cleaning the window of LiDAR for vehicles can further include the following step.

At step C, the LiDAR can be controlled to remove point cloud data under a scanning orientation when the predetermined distance is equal to zero.

In some embodiments, the speed at which the wiper wipes across the projection area can be different from the speed at which the LiDAR scans. The current scanning orientation of the LiDAR can be ahead of or behind the current position of the wiper at the beginning, but the predetermined distance can be zero during the cleaning. For example, when the wiper starts to swing, the current position of the wiper can be ahead of the current scanning orientation of the LiDAR. The scanning speed of the LiDAR can be faster than the wiper. The current scanning orientation of the LiDAR can catch up with the current position of the wiper before the wiper leaving the projection area. For another example, when the wiper starts to swing, the current position of the wiper can be ahead of the current scanning orientation of the LiDAR. After several swings, the wiper can swing in the opposite direction to the scanning direction of the LiDAR. Then, the current scanning orientation of the LiDAR and the current position of the wiper can coincide at a certain moment. As yet another example, the vehicle's driver can change the swinging speed of the wiper so that it cannot always ensure that current position of the wiper is ahead of or behind the current scanning orientation of the LiDAR. When the wiper blocks the current scanning orientation of the LiDAR, it can be deemed that the predetermined distance between the current position of the wiper and the current scanning orientation of the LiDAR is equal to zero. By removing the point cloud data at the scanning orientation when the predetermined distance is equal to zero (e.g., removing the point cloud data disturbed by the wiper), the accuracy of the LiDAR detection results can be improved.

In some embodiments, the LiDAR can be controlled to remove a point cloud data under the scanning orientation when the predetermined distance is equal to zero. By doing so, the impact of the wiper on the LiDAR detection results can be effectively reduced or avoided. This can not only improves the accuracy of the LiDAR detection results, but also is easy to implement.

In some embodiments, when the wiper blocks the current scanning orientation of the LiDAR, the LiDAR can be controlled not to collect point cloud data under the current scanning orientation. By doing so, the point cloud data under the scanning orientation when the predetermined distance is equal to zero can be removed.

In some embodiments, the LiDAR can be controlled to delete the point cloud data collected under the scanning orientation blocked by the wiper. By doing so, the point cloud data under the scanning orientation when the predetermined distance is equal to zero can be removed.

In some embodiments, the LiDAR can be controlled to replace the point cloud data under the scanning orientation when the predetermined distance is equal to zero with point cloud data in adjacent frames, which can not only effectively reduce or avoid the impact of the wiper on the LiDAR detection results, and also ensure the integrity of the point cloud data output by the LiDAR.

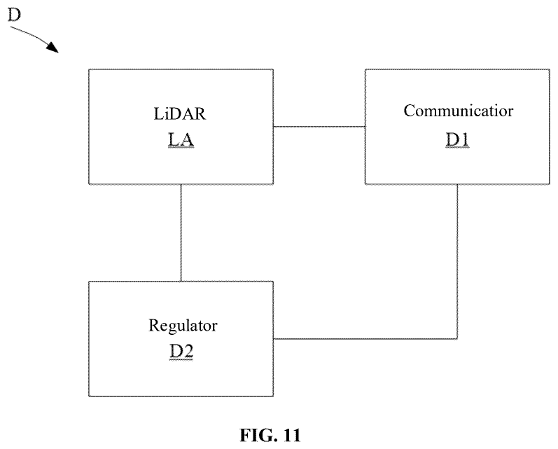

To clean the field of view of the LiDAR for vehicles more conveniently, some embodiments further provide a ranging device, which can perform any of the embodiments of the above method for cleaning the window of the LiDAR for vehicles. FIG. 11 shows a schematic structural diagram of an example ranging device, consistent with some embodiments of this disclosure. In some embodiments, referring to FIG. 11, the ranging device D includes a LiDAR, a communicator, and a regulator. The LiDAR LA can be located inside a vehicle cover. A field of view of the LiDAR can form a projection area on the vehicle cover. A cleaning range of a wiper can at least partially coincide with the projection area. The communicator D1 can communicate with the wiper and the LiDAR LA. The regulator D2 can regulate operating parameter of the wiper or the LiDAR LA to maintain a predetermined distance between a current position of the wiper and a current scanning orientation of the LiDAR.

In some embodiments, the ranging device D can communicate with the wiper and the LiDAR LA via the communicator D1, and regulate the operating parameter of the wiper or the LiDAR via the regulator D2, so that the predetermined distance between the current position of the wiper and the current scanning orientations of the LiDAR can be maintained. By doing so, the normal operation of the LiDAR LA can be less affected or not affected when the wiper is in operation, and ensuring the detection performance of the LiDAR LA.

In some embodiments, the ranging device can also include an installation device for fixing the LiDAR, and the installation device includes a mount an at least one seal. The mount can be arranged on inside of the vehicle cover and used to fix the LiDAR. The multiple seals can be installed on the inside of the vehicle cover. The multiple seals, the inside of the vehicle cover and the LiDAR can form an enclosed space.

The installation device can form an enclosed space with the inside of the vehicle cover and the LiDAR by using the multiple seals. Therefore, it is possible to clean the vehicle cover without cleaning a light cover of the LiDAR, which can ensure the long-term stable and reliable operation of the LiDAR. The enclosed space can also reduce or prevent laser light from emitting from the gap between the LiDAR's light cover and the vehicle cover, which can reduce safety hazards.

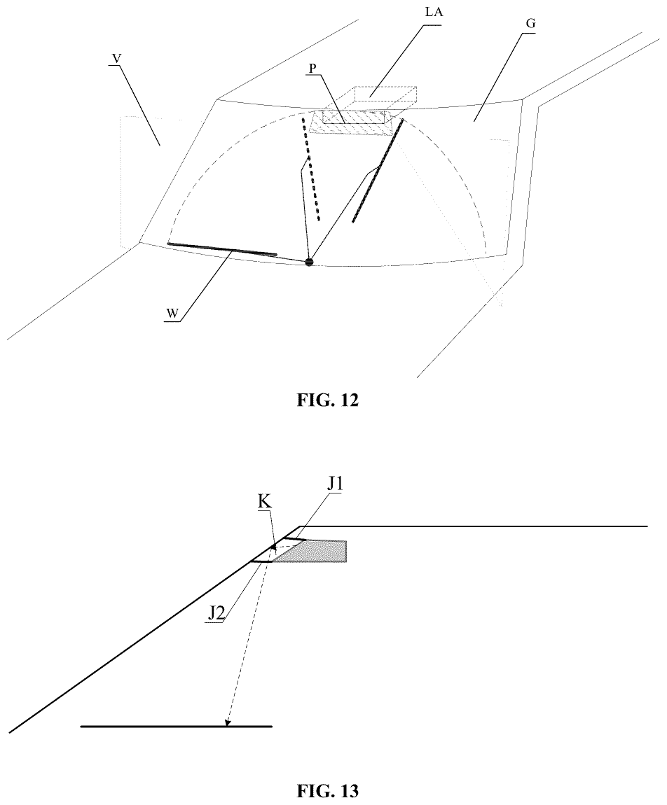

FIG. 12 shows a schematic diagram of the installation and position of an example ranging device, consistent with some embodiments of this disclosure. FIG. 13 shows a schematic side view of the installation and position of an example ranging device, consistent with some embodiments of this disclosure. In some embodiments, referring to FIGS. 12 and 13, seals J1 and J2 form an enclosed space K with the inside of the vehicle cover and the LiDAR LA.

In some embodiments, the inside of the seal can further include a light-absorbent layer (not shown) to reduce the generation of stray light.

In some embodiments, the vehicle cover can be a front windshield, a rear windshield, or other vehicle windows. For example, still referring to FIG. 12, the LiDAR can be installed in the middle of the upper part of the front windshield. For another example, the LiDAR can also be installed at other suitable positions on the front windshield, such as the left, middle or right parts of the upper edge of the front windshield. For another example, the LiDAR can also be installed in the left, middle or right parts of the lower edge of the front windshield.

It can be understood that some embodiments of this disclosure do not limit the installation location of the LiDAR.

In some embodiments, the LiDAR can include a light cover, and the LiDAR is installed inside the vehicle cover together with the light cover.

In some other embodiments, the LiDAR can include no light cover, and the vehicle cover can be reused as the light cover of the LiDAR. For example, the front windshield can be reused as the light cover of the LiDAR. The number of components through which laser light is transmitted can be reduced, accordingly the laser transmittance can be improved and the system cost can be saved.

Some embodiments of this disclosure also provide a vehicle, which can perform any of the embodiments of the above-mentioned method for cleaning the window of the LiDAR for vehicles. Continue with reference to FIGS. 11 and 12, the vehicle can include a vehicle cover G, a wiper W, a LiDAR LA, a communicator D1 and a regulator D2. The LiDAR LA is located inside the vehicle cover G, a field of view of the LiDAR LA forms a projection area P on the vehicle cover G, and a cleaning range of the wiper W at least partially coincide with the projection area P. The communicator D1 can be used to communicate with the wiper W and the LiDAR LA. The regulator D2 can be used to regulate operating parameter of the wiper W or the LiDAR LA to maintain a predetermined distance between a current position of the wiper W and a current scanning orientation of the LiDAR LA.

In some embodiments, the LiDAR LA can be installed inside the vehicle cover G, and the vehicle can communicate with the wiper W and the LiDAR LA via the communicator D1. The vehicle can regulate operating parameter of the wiper W or the LiDAR LA via the regulator D2 to maintain a predetermined distance between the current position of the wiper W and the current scanning orientation of the LiDAR, and ensuring that the normal operation of the LIDAR LA can be less affected or not affected when the wiper W is in operation. By doing so, the detection performance of the LiDAR LA can be improved or ensured. In addition, when the wiper is reused to clean the LiDAR's field of view, no cleaning device is needed, which is beneficial to the overall appearance of the vehicle and has a good cleaning effect.

In some embodiments, to further improve the detection performance of the LiDAR, the transmittance of the projection area of the vehicle cover to the laser emitted by the LiDAR can be greater than that of other areas of the vehicle cover.

For example, an anti-reflective coating can be provided in the projection area to increase its transmittance to the laser light emitted by the LiDAR.

For another example, the composition of the vehicle cover in the projection area can be changed to increase its transmittance to the laser light emitted by the LiDAR.

In some embodiments, to further improve the detection performance of the LiDAR, heating wires can be arranged in the projection area to reduce or prevent rain and snow from freezing in the projection area in winter, which would affect the detection performance of the LiDAR and the normal operation of the wiper.

In some embodiments, the methods of the present application can be performed by a LiDAR or a wiper or a vehicle. Some steps can be performed by a LiDAR. For example, the LiDAR can send signals to the wiper or to the LiDAR's own controller to change the operating parameter. For another example, the wiper can obtained the non-ranging time period of the frame of the LiDAR. For another example, the vehicle can send signals to the wiper or to the LiDAR to change the operating parameter.

The terms “or” and “and/or” of this disclosure describe an association relationship between associated objects, and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the symbol “/” herein indicates that the associated objects before and after the character are in an “or” relationship. In this disclosure, the term “at least one of A or B” has a meaning equivalent to “A or B” as described above. The term “at least one of A, B, or C” has a meaning equivalent to “A, B, or C” as described above.

In this disclosure, the terms “a,” “an,” and “the” are intended to represent singular or plural forms, unless expressly stated otherwise in the context. The term “multiple” in this disclosure refers to a number of two or more. For example, multiple objects can include two objects, or more than two objects.

It can be understood that the modules units in the embodiments of this disclosure can be consisted of discrete devices, or can be implemented by a single electrical chip.

It should be noted that the terms “first” and “second” in the embodiments of this disclosure are only used for differential description and do not impose any restrictions on the models of components.

While the embodiments of this disclosure are disclosed as above, this disclosure is not limited thereto. Any person skilled in the art can make various changes and modifications without departing from the spirit and scope of this disclosure. Therefore, the protection scope of this disclosure should be subject to the scope defined by the claims.

1. A method for cleaning a window of a LiDAR for a vehicle, the method comprising:
regulating an operating parameter of at least one of a wiper of the vehicle or the LiDAR, wherein a cleaning operation of the wiper is configured to cooperate with a detection operation of the LiDAR, and wherein the LiDAR is located inside a vehicle cabin, a field of view of the LiDAR is configured to form a projection area on a vehicle cover, and a cleaning range of the wiper is configured to at least partially coincide with the projection area; and
controlling the wiper to perform the cleaning operation.

2. The method of claim 1, wherein regulating the operating parameter of the at least one of the wiper or the LiDAR comprises:
regulating the operating parameter of the at least one of the wiper or the LiDAR to maintain a predetermined distance between a current position of the wiper and a current scanning orientation of the LiDAR.

3. The method of claim 2, wherein regulating the operating parameter of the at least one of the wiper or the LiDAR to maintain the predetermined distance between the current position of the wiper and the current scanning orientation of the LiDAR comprises:
regulating the operating parameter of the at least one of the wiper or the LiDAR, wherein a time period is within a non-ranging time period of a frame of the LiDAR, and the wiper is configured to wipe across the projection area during the time period.

4. The method of claim 2, wherein regulating the operating parameter of the at least one of the wiper or the LiDAR further comprises:
determining whether a duration for the wiper to wipe across the projection area is shorter than or equal to a non-ranging duration of the frame of the LiDAR; and
based on a determination that the duration for the wiper to wipe across the projection area is not shorter than or equal to the non-ranging duration of the frame of the LiDAR, changing the operating parameter of the at least one of the wiper or the LiDAR to cause the duration for the wiper to wipe across the projection area to be shorter than or equal to the non-ranging duration of the frame of the LiDAR.

5. The method of claim 4, wherein changing the operating parameter of the at least one of the wiper or the LiDAR to cause the duration for the wiper to wipe across the projection area to be shorter than or equal to the non-ranging duration of the frame of the LiDAR comprises at least one of:
accelerating an operating speed of the wiper;
lengthening the non-ranging duration of the frame of the LiDAR; or
narrowing a scope of the projection area.

6. The method of claim 5, wherein lengthening the non-ranging duration of the frame of the LiDAR comprises:
keeping a frame rate of the LiDAR unchanged and shortening a ranging duration within the frame of the LiDAR; or
keeping the ranging duration within the frame of the LiDAR unchanged and reducing the frame rate of the LiDAR; or
reducing the frame rate of the LiDAR and shortening the ranging duration within the frame of the LiDAR.

7. The method of claim 3, wherein regulating the operating parameter of the at least one of the wiper or the LiDAR comprises:
determining the non-ranging time period of the frame of the LiDAR;
determining a first duration for the wiper to enter the projection area;
determining a first waiting duration based on the non-ranging time period of the frame of the LiDAR and the first duration, wherein the first waiting duration is a waiting duration before the wiper is started; and
in response to the wiper receiving a start signal, controlling the wiper to start after the first waiting period, wherein the wiper is configured to wipe across the projection area during the non-ranging time period of the LiDAR.

8. The method of claim 3, wherein regulating the operating parameter of the at least one of the wiper or the LiDAR comprises:
determining a first time period, wherein the wiper is located within the projection area during the first time period; and
changing the operating parameter of the LiDAR, wherein the non-ranging time period of the LiDAR is configured to coincide with the first time period.

9. The method of claim 2, wherein regulating the operating parameter of the at least one of the wiper or the LiDAR to maintain the predetermined distance between the current position of the wiper and the current scanning orientation of the LiDAR comprises:
regulating the operating parameter of the at least one of the wiper or the LiDAR, wherein the current position of the wiper is configured to be ahead of or behind the current scanning orientation of the LiDAR.

10. The method of claim 9, wherein regulating the operating parameter of the at least one of the wiper or the LiDAR comprises:
determining the current scanning orientation of the LiDAR;
determining the current position of the wiper; determining a second waiting duration based on the current scanning orientation of the LiDAR and the current position of the wiper, wherein the second waiting duration is a waiting duration before the wiper is started; and
controlling the wiper to start after the second waiting duration, wherein the current position of the wiper is configured to be ahead of or behind the current scanning orientation of the LiDAR.

11. The method of claim 9, wherein regulating the operating parameter of the at least one of the wiper or the LiDAR comprises:
determining the current position of the wiper; and
changing the operating parameter of the LiDAR, wherein the current scanning orientation of the LiDAR is configured to be ahead of or behind the current position of the wiper.

12. The method of claim 1, further comprising:
controlling the LiDAR to remove a point cloud data under a scanning orientation when a current position of the wiper and the scanning orientation are partially or fully overlapping.

13. The method of claim 12, wherein controlling the LiDAR to remove the point cloud data under the scanning orientation when the current position of the wiper and the scanning orientation are partially or fully overlapping comprises at least one of:
controlling the LiDAR not to collect the point cloud data at the current scanning orientation; or
controlling the LiDAR to delete the point cloud data collected at the current scanning orientation.

14. The method of claim 1, further comprising:
controlling the LiDAR to replace a point cloud data under the scanning orientation when a current position of the wiper and the scanning orientation are partially or fully overlapping with a point cloud data in adjacent frames.

15. A ranging device, comprising:
a LiDAR located inside a vehicle cabin, wherein a field of view of the LiDAR is configured to form a projection area on a vehicle cover, and a cleaning range of a wiper is configured to at least partially coincide with the projection area;
a communicator configured to communicate with the wiper and the LiDAR; and
a regulator configured to regulate an operating parameter of at least one of the wiper or the LiDAR to maintain a predetermined distance between a current position of the wiper and a current scanning orientation of the LiDAR.

16. The ranging device of claim 15, further comprising an installation device for fixing the LiDAR, wherein the installation device comprises:
a mount arranged on an inside of the vehicle cover and configured to fix the LiDAR; and
a plurality of seals installed on the inside of the vehicle cover, wherein the plurality of the seals, the inside of the vehicle cover, and the LiDAR form an enclosed space.

17. The ranging device of claim 16, wherein the vehicle cover comprises at least one of a front windscreen or a rear windscreen.

18. A vehicle, the vehicle comprising:
a cabin;
a vehicle cover;
a wiper;
a LiDAR located inside the vehicle cabin, wherein a field of view of the LiDAR is configured to form a projection area on the vehicle cover, and a cleaning range of the wiper is configured to at least partially coincide with the projection area;
a communicator configured to communicate with the wiper and the LiDAR; and
a regulator configured to regulate an operating parameter of at least one of the wiper or the LiDAR to maintain a predetermined distance between a current position of the wiper and a current scanning orientation of the LiDAR.

19. The vehicle of claim 18, wherein a transmittance of the projection area of the vehicle cover to a laser emitted by the LiDAR is greater than a transmittance of an area of the vehicle cover differs from the projection area.

20. The vehicle of claim 19, wherein the projection area of the vehicle cover further comprises at least one of an anti-reflective coating or a heating wire.
